(19) United States
(12) Patent Application Publication
(10) Pub. No.: US 2026/0022783 A1
(43) Pub. Date: Jan. 22, 2026

(54) METHOD AND SYSTEM FOR SINGLE-MOTOR-DRIVEN, DUAL-SPEED, MULTI-TORQUE-INITIATING DEVICE

(71) Applicant: Tri-Tec Manufacturing, LLC, Kent, WA (US)

(72) Inventor: Gregory James CHAMPOUX, Kent, WA (US)

(73) Assignee: Tri-Tec Manufacturing, LLC, Kent, WA (US)

(21) Appl. No.: 19/244,859

(22) Filed: Jun. 20, 2025

Related U.S. Application Data
(60) Provisional application No. 63/672,156, filed on Jul. 16, 2024.

(51) Int. Cl. F16K 31/53; F16H 19/08

(52) U.S. Cl. CPC F16K 31/53; F16H 19/08

(57) ABSTRACT

A method of operating a single-motor-driven, dual-speed, multi-torque-initiating valve actuator is provided. The method includes initiating travel of a valve using a single-motor-driven actuator, wherein the single-motor-driven actuator includes both a high-speed drive and low speed drive. The method includes engaging both the high-speed and low-speed drives to off-seat the valve; disengaging the high-speed drive using a mechanical clutch; and seating the valve by continuing the traveling of the valve with only the low-speed drive. A system having a valve; a single-motor-driven, dual-speed, multi-torque-initiating valve actuator that includes: a high-speed drive having a high-speed worm screw configured to drive a high-speed worm gear, a low-speed drive having a low-speed worm screw configured to drive a low-speed worm gear, is also provided.

### STATEMENT OF GOVERNMENT INTEREST

This invention was made with government support under N00024-18-C-2130 awarded by Department of Defense. The government has certain rights in the invention.

### BACKGROUND

### Technical Field

The present disclosure is related to a method of operation for a single-motor-driven, dual-speed, multi-torque-initiating device, such as a valve actuator.

### Description of the Related Art

Most electronically actuated valves operate at one continuous speed and torque throughout their travel span even when high torque is not required for the greater part of the operation. In the case of some quarter-turn valves, for example, high torque output is typically required during a very short section of the travel span-during seating or unseating of the valve. This high torque output is necessary for approximately 3 degrees of the 90-degree travel. During the remaining 87 degrees of travel, very little torque is required, and the speed remains constant throughout travel.

Because speed and torque are inversely related in a mechanism with fixed power capacity, the speed can be increased for the segment of travel that requires low torque. To achieve the balance of high speed/low torque for the 87 degrees of travel, with the low speed/high torque required for valve seating and unseating, a method was devised to change speeds during valve travel using a single motor and without a conventional transmission.

### BRIEF SUMMARY

A method of the disclosure described herein takes advantage of a planetary gearsets' ability to act as a differential. This device utilizes a single motor to simultaneously drive both the sun gear and the previously fixed ring gear of a single planetary set. A slip clutch allows the ring gear drive to slip (preventing the high-speed drive from engaging) when the torque requirements are too great, providing the ability for the actuator to operate at two speeds and, thus, two torques.

A method of operation may be summarized as including: initiating traveling of a valve from single motor-driven actuator, wherein the single-motor-driven actuator may include a high-speed drive and a low-speed drive; engaging both the high-speed and low-speed drives to off-seat the valve; disengaging the high-speed drive using a mechanical clutch; and seating the valve by continuing the traveling of the valve with only the low-speed drive.

The low-speed drive may be permanently coupled to the motor. The low-speed drive may include a low-speed clutch. The low-speed clutch may be configured to slip only if the valve is blocked or prevented from normal operation. The method may further include a low-speed worm screw driving a low-speed worm gear. The low-speed worm gear may be directly coupled to a sun gear in a planetary gear set. The high-speed drive may be configured to include a high-speed worm screw. The method may further include driving a high-speed worm gear with the high-speed worm screw. The high-speed worm gear may be configured to operate as the planetary gear set, having external teeth in direct contact with the high-speed worm gear, and internal teeth in direct contact with a plurality of planetary gears. Driving both a ring of the planetary gear set, and the sun gear may result in the planetary gear set configured to operate as a differential. The high-speed drive may be configured to slip via the mechanical clutch when the valve experiences high torque within a set point near a closed position of the valve.

A system may be summarized as including: a valve; a single-motor-driven, dual-speed, multi-torque-initiating valve actuator, the valve actuator including: a high-speed drive having a high-speed worm screw configured to drive a high-speed worm gear, a low-speed drive having a low-speed worm screw configured to drive a low-speed worm gear, wherein the valve actuator may be configured to: initiate valve travel with the single-motor-driven actuator that includes the high-speed drive and the low-speed drive; engaging both the high-speed and low-speed drives to off-seat the valve; disengaging the high-speed drive using a mechanical clutch; and continuing valve travel with the low-speed drive to seat the valve.

The system may include a sun gear and a plurality of planetary gears positioned within the high-speed worm gear. The low-speed worm screw is coupled to the low-speed worm gear. The high-speed worm gear may have external teeth and internal teeth, and wherein the planetary gears may mesh with the internal teeth and the high-speed worm screw may mesh with the external teeth. The high-speed worm gear may be configured to operate as a planetary ring gear.

A method of operation may be summarized as including: opening and closing a valve with a single-motor-driven, dual-speed, multi-torque-initiating valve actuator having a motor drive spur gear; a high-speed worm clutch; high-speed worm screw; a low-speed worm screw; a low-speed worm gear; a sun gear; and a planetary ring gear, the opening and closing may include: initiating valve travel wherein the valve includes a high-speed drive and a low-speed drive; engaging both the high-speed and low-speed drives to off-seat the valve; disengaging the high-speed drive using a mechanical clutch; and continuing valve travel with the low-speed drive to seat the valve.

The planetary ring gear may have external gear teeth and internal gear teeth. The low-speed drive may be permanently coupled to the motor and remains in continuous operation throughout the duration of valve travel.

### BRIEF DESCRIPTION OF THE SEVERAL VIEWS OF THE DRAWINGS

FIG. 1 shows a perspective view of an example embodiment of a gearing diagram in which a method of operating a single-motor-driven, dual-speed, multi-torque-initiating valve actuator may be implemented.

FIG. 2 shows a functional block diagram of the method of operating a single-motor-driven, dual-speed, multi-torque-initiating valve actuator in the gearing diagram of FIG. 1.

### DETAILED DESCRIPTION

For purposes of terminology, the term used “valve actuator” may be used interchangeably with “actuator valve” or “actuator” and should be interpreted to represent the same element, and would be understood by a person ordinarily skilled in the art. Additionally, the term “valve travel” may be used interchangeably with “travel,” “traveling,” or “stroke,” and should be understood to mean the distance a stem travels within a valve to go from fully closed to fully open, or vice versa, and also the term “throttling, which can be used in applications where intermediate positions may be utilized.

A method for operating a single-motor-driven, dual-speed, multi-torque-initiating valve actuator is derived by coupling the higher speed potential of a ring-driven planetary set with the higher-torque potential of a sun-driven planetary set. An actuator is defined as a device that controls the position of the flow-control element on a control valve by automatically adjusting the position of the valve stem.

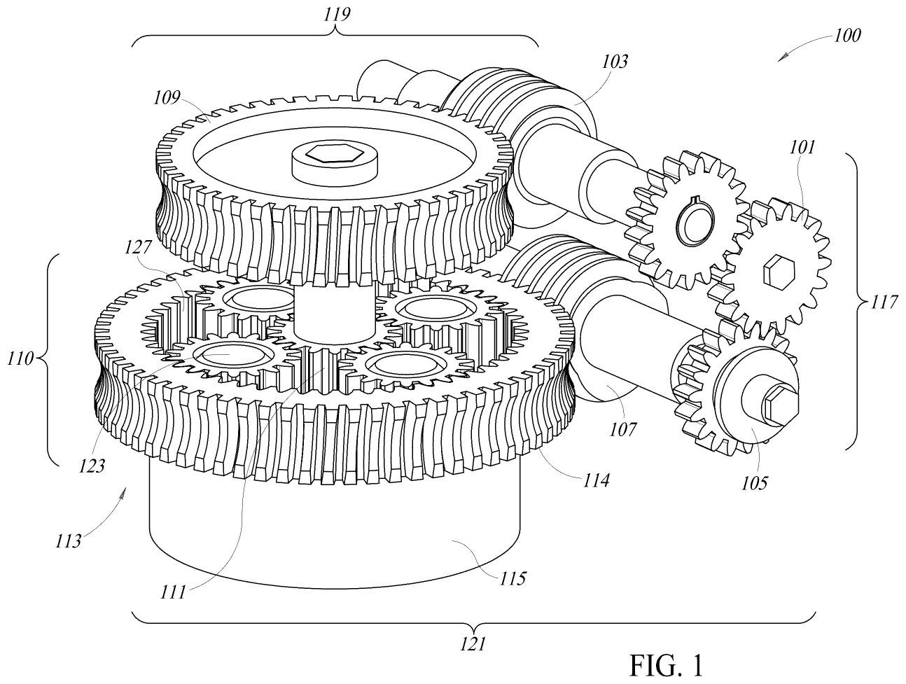

FIG. 1 shows a perspective view of an example embodiment of a gearing diagram for a valve actuator system 100 in which a method of operating a single-motor-driven, dual-speed, multi-torque-initiating valve actuator may be implemented. The components of the valve actuator system 100 comprises a single motor or motor drive spur 101. The motor drive spur 101 transfers mechanical motion from the single motor (not shown) to increase or decrease the torque on the valve actuator. Input from the motor drive spur 101 drives a spur gear drive 117 having two separate gear paths.

The first gear path comprises a low-speed worm screw 103 and a low-speed worm gear 109 with a low-speed clutch (not shown), which collectively form a low-speed drive 119. The motor 101 supplies rotational power to the low-speed worm 109, which rotates against the low-speed worm screw 103 to an output or actuator 115. During normal operation, the low-speed drive 119 is permanently coupled to the motor 101, such that the low-speed clutch should only slip if something is blocking the valve. The low-speed drive 119 typically operates during off-seating or seating of the valve because during typical seating or off-seating of a valve, low speed along with high torque is required.

The second gear path comprises a high-speed worm screw 107 with a high-speed worm clutch 105. The second gear path further comprises a high-speed worm gear 113 that operates as both a planetary ring gear and as the high-speed worm gear 113, which will be explained in greater detail below. Together, the high-speed worm screw 107 and high-speed worm gear 113 collectively form a high-speed drive 121.

During operation of the actuator while in high-speed drive 121, the high-speed worm screw 107 drives the high-speed worm gear 113 by meshing with external teeth 114 of the ring gear 113. While performing a closing operation of the valve, the high-speed drive 121 quickly drives the actuator 115 from an open position to within 3 degrees of a closed position of the valve. The high-speed drive 121 and high-speed clutch 105 are designed to slip when the valve experiences high torque at the valves seat, which essentially prevents the high-speed drive 121 from engaging. Once the valve approaches within 3 degrees of the closed position of the valve, in which the valve generates a high-torque amount, the high-speed clutch mechanically slips, thus engaging the low-speed drive 119 and allowing the low-speed, high-torque components to take over the operation.

A single planetary gear set 110 comprises the planetary ring gear 113 and a sun gear 111. The planetary gear set 110 provides the single motor 101 with the ability for the actuator 115 to operate at two speeds (low-speed drive, high-speed drive), and two torques. The sun gear 111 operates and functions as the input and driver of the planetary ring set 110 via the low-speed drive 119. A plurality of planetary gears 123 are positioned within the planetary gear set 110 and are configured to rotate around the sun gear 111. The planetary gears 123 are meshed against internal teeth 127 of the ring gear 113. The method described herein utilizes the advantage and benefit of the planetary gearsets' ability to act as a differential and convert to a different ratio. For example, driving a sun gear in a planetary gearset while keeping the ring gear fixed typically results in a ratio of between 3:1 and 10:1. Whereas driving the ring of a planetary gearset while keeping the sun gear fixed typically results in a gear ratio of between 1:1 and 1:8. For example, for every one revolution of the input gear, the output gear will make eight revolutions.

In the method described herein, the low-speed drive 119 remains operable during the entire stroke of the valve actuation. In other words, both the low-speed drive 119 and high-speed drive 121 initially remain operable at the same, for example when off-seating the valve. As mentioned above, the low-speed worm screw 103 drives the low-speed worm gear 109, which is directly coupled to the sun gear 111 of the planetary gear set 110. The low speed and high torque output at this stage of valve operation is needed during seating or off-seating of the valve. In order to achieve the capability of dual speeds with a single motor, the method described herein utilizes the ring gear 113 with both the internal and external sets of teeth 127, 114, respectively.

As demonstrated in FIG. 1, the valve actuator system 100 includes the motor drive spur 101 that meshes with both the low-speed worm screw 103 and the high-speed worm screw 105. The low-speed worm screw 103 meshes with the low-speed worm gear 109 that is coupled to the high-speed worm gear 113 via the sun gear 111. The high-speed worm gear 113 has a size that is larger than the low-speed worm gear 113. The sun gear 111 is centrally positioned within the high-speed worm gear 113 and meshes with the plurality of planetary gears 123.

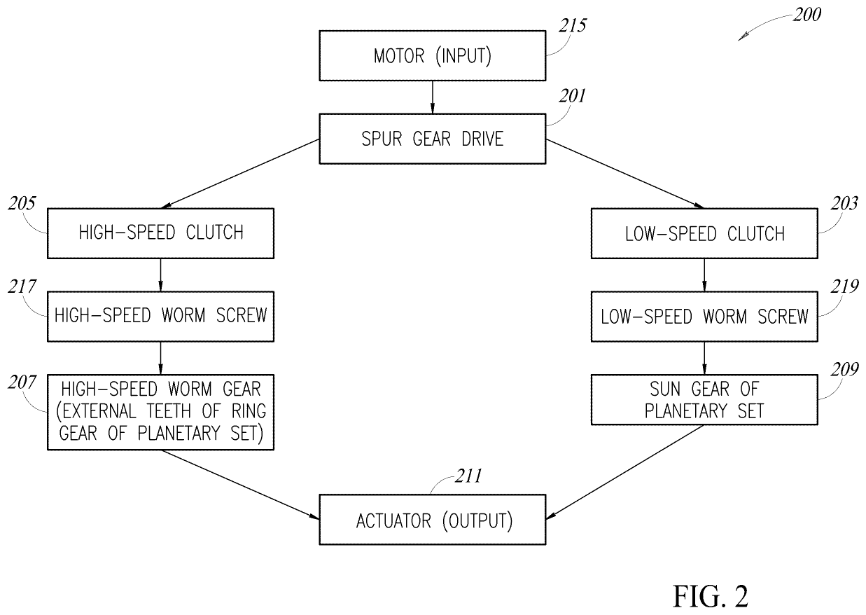

FIG. 2 illustrates a functional block diagram method 200, which may be implemented by the valve actuator system 100 when closing or traveling of a valve, for example during operation of a quarter-turn valve (i.e., a method of valve operation that involves a 90-degree turning of a stem to fully open or fully close a valve). As previously noted, high torque output is only needed during a small duration of valve travel, e.g., approximately 3 degrees for a quarter-turn valve.

The method 200 will begin with input from a single motor Block 101 that drives a spur gear drive Block 201 having two separate gear paths. The spur gear drive 201 is used with the motor 101 to transmit power between the two gear paths. During normal operation, both the high-speed drive 121 and the low-speed drive 119 are simultaneously engaged for valve actuation. As shown in FIG. 2, there is a functional relationship between components of both the high-speed drive 121 and the low-speed drive 119.

A low-speed clutch Block 203 is coupled to a low-speed worm gear and is manipulated by a low-speed worm screw Block 219. The low-speed clutch Block 203 is configured to slip, or disengage, only if a foreign object or other unbeknownst material blocks normal operation of the valve. The low-speed worm screw Block 219 is coupled to, via the low-speed worm gear, a sun gear of a planetary set Block 209. The low-speed worm screw transmits rotational power via the low-speed worm gear to drive rotation of the sun gear of the planetary set.

A high-speed clutch Block 205 is coupled to a high-speed worm screw Block 217. The high-speed worm screw Block 217 is directly coupled to and drives a high-speed worm gear Block 207. As mentioned above, the high-speed worm gear Block 207 functions as both the high-speed worm gear and a planetary gear set. The high-speed worm screw Block 217 drives the high-speed worm gear Block 207 by meshing with external teeth of the planetary gear set (high-speed worm gear). Both the low-speed drive path and high-speed drive path discussed produce an output Block 211 to the valve actuator. In a closing operation, or seating a valve, the high-speed drive 121 will disengage via the high-speed slip clutch Block 205 when high-torque is experienced, e.g., within three degrees of the shut position, allowing the the low-speed drive 119 to assume control of the valve speed at its seat.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
initiating traveling of a valve from a single motor-driven actuator,
wherein the single-motor-driven actuator includes a high-speed drive and a low-speed drive;
engaging both the high-speed and low-speed drives to off-seat the valve;
disengaging the high-speed drive using a mechanical clutch; and
seating the valve by continuing the traveling of the valve with only the low-speed drive.

2. The method of claim 1, wherein the low-speed drive is permanently coupled to the motor.

3. The method of claim 1, wherein the low-speed drive comprises a low-speed clutch.

4. The method of claim 1, wherein the low-speed clutch is configured to slip only if the valve is blocked.

5. The method of claim 1, further comprising the low-speed drive operating during the entire stroke of the actuation of the valve.

6. The method of claim 1, further comprising a low-speed worm screw driving a low-speed worm gear.

7. The method of claim 1, wherein the low-speed worm gear is directly coupled to a sun gear in a planetary gear set.

8. The method of claim 1, wherein the high-speed drive is configured to include a high-speed worm screw.

9. The method of claim 1, further comprising driving a high-speed worm gear with the high-speed worm screw.

10. The method of claim 9, wherein the high-speed worm gear is configured to operate as the planetary gear set, having external teeth in direct contact with the high-speed worm gear, and internal teeth in direct contact with a plurality of planetary gears.

11. The method of claim 1, wherein driving both a ring of the planetary gear set, and the sun gear results in the planetary gear set configured to operate as a differential.

12. The method of claim 1, wherein the high-speed drive is configured to slip via the mechanical clutch when the valve experiences high torque within a set point near a closed position of the valve.

13. A system, comprising:
a valve;
a single-motor-driven, dual-speed, multi-torque-initiating valve actuator, the valve actuator including:
a high-speed drive having a high-speed worm screw configured to drive a high-speed worm gear,
a low-speed drive having a low-speed worm screw configured to drive a low-speed worm gear,
wherein the valve actuator is configured to:
initiate valve travel with the single-motor-driven actuator that includes the high-speed drive and the low-speed drive;
engage both the high-speed and low-speed drives to off-seat the valve;
disengage the high-speed drive using a mechanical clutch; and
continue valve travel with the low-speed drive to seat the valve.

14. The system of claim 13, further comprising a sun gear and a plurality of planetary gears positioned within the high-speed worm gear.

15. The system of claim 14, wherein the low-speed worm gear is coupled to a side of the sun gear, coupling the low-speed worm gear to the high-speed worm gear.

16. The system of claim 14, wherein the high-speed worm gear has external teeth and internal teeth, and wherein the planetary gears mesh with the internal teeth and the high-speed worm screw meshes with the external teeth.

17. The system of claim 13, wherein the high-speed worm gear is configured to operate as a planetary ring gear.

18. A method, comprising:
opening and closing a valve with a single-motor-driven, dual-speed, multi-torque-initiating valve actuator having a motor drive spur; a high-speed worm clutch; high-speed worm screw; a low-speed worm screw; a low-speed worm gear; a sun gear; and a planetary ring gear, the opening and closing including:
initiating valve travel wherein the valve includes a high-speed drive and a low-speed drive;
engaging both the high-speed and low-speed drives to off-seat the valve;
disengaging the high-speed drive using a mechanical clutch; and
continuing valve travel with the low-speed drive to seat the valve.

19. The method of claim 18, wherein the planetary ring gear has external gear teeth and internal gear teeth.

20. The method of claim 18, wherein the low-speed drive is permanently coupled to the motor and remains in continuous operation throughout the duration of valve travel.
